(19) United States
(12) Patent Application Publication
(10) Pub. No.: US 2016/0378181 A1
(43) Pub. Date: Dec. 29, 2016

(54) Method for Image Stabilization

(71) Applicant: Christian NASCA, Singen (DE)

(72) Inventor: Christian Nasca, Singen (DE)

(21) Appl. No.: 14/909,021

(22) PCT Filed: Dec. 22, 2014
(86) PCT No.: PCT/EP2014/079053

§ 371 Date: Jan. 29, 2016

(30) Foreign Application Priority Data
Mar. 17, 2014 (DE) 10 2014 103 621.2

(51) Int. Cl. G06F 3/01; G06T 7/00; G09G 5/00; G06F 3/0346; G06T 7/20

(52) U.S. Cl. CPC G06F 3/013; G06F 3/0346; G06T 7/20; G09G 5/005; G06T 7/0042; G09G 2320/068

(57) ABSTRACT

A method with a device (10) that includes at least one display unit (12) for presenting at least one display content (14) and includes at least one first sensor unit (16). At least one display content (14) of the at least one display unit (12) is at least partially stabilized for at least one viewer (18). A position of the at least one display unit (12) with respect to at least one external reference point (20, 46) is captured by the at least one first sensor unit (16).

### STATE OF THE ART

The invention relates to an image stabilizing method according to the preamble of claim 1.

In U.S. Pat. No. 6,906,754 B1 an image stabilizing method has already been proposed, in which movements of a display apparatus are captured by means of two accelerometers. Captured acceleration values are used to shift a display content counter to the movements of the display apparatus, thus compensating the movements of the display apparatus and stabilizing the display content. Herein merely movements and/or orientations of the display apparatus with respect to a gravitational direction can be captured by the two accelerometers.

The objective of the invention lies in particular in providing a generic method with advantageous features as regards a stabilization of display contents. The objective is achieved according to the invention by the features of patent claims 1 and 14, while advantageous embodiments and further developments of the invention may be gathered from the dependent claims.

### ADVANTAGES OF THE INVENTION

The invention is based on a method with a device which comprises at least one display unit for presenting at least one display content and comprises at least one first sensor unit, wherein at least one display content is at least partially stabilized for at least one viewer of the at least one display unit.

It is proposed that a position of the at least one display unit with respect to at least one external reference point is captured by the at least one first sensor unit.

The device is in particular a mobile apparatus, which is in particular portable and/or mountable into a vehicle, e.g. a smartphone, a tablet computer, a mobile phone, a PDA, an e-book reader, a navigation apparatus, and/or an apparatus mounted in a vehicle, e.g. an on-board computer. In particular, the device may be further embodied as a stationary training device or as a component of a stationary training device, e.g. a treadmill, a cross-trainer, an elliptical-trainer, a spinning bike and/or such like. A “display unit” is to mean, in this context, in particular a unit with at least one display element, in particular an optical display element. An “optical display element” is to mean in particular a lighting element, preferably an LED, and/or a preferably backlit display unit, in particular a matrix display unit, preferentially an LCD display, an OLED display, a TFT display and/or electronic paper, in particular e-paper and electronic ink. A “display content” is to mean, in this context, in particular a content which is presented by the display unit, in at least one operating state of the display unit, in particular such that it is visible to a viewer, in particular by means of the at least one display element of the display unit. In particular, the display content is a text and/or an image and/or a graphic design and/or a further, in particular optically presentable information. By the at least one display content being at least partially “stabilized” for at least one viewer, it is to be understood, in this context, in particular that, in case of a movement of the at least one display unit, in particular of a movement with respect to a gravitational direction, the at least one display content is adjusted in such a way that the movement of the at least one display unit, in particular the movement with respect to the gravitational direction, is at least substantially compensated, in particular for the at least one viewer. By the movement that has taken place being at least substantially “compensated” in particular for the at least one viewer, it is to be understood, in this context, in particular that the at least one display content, in particular a position and/or a size and/or in particular a geometry of the at least one display content is at least substantially kept up, in particular for the at least one viewer. “At least substantially kept up” is to mean, in this context, in particular that a position and/or a size and/or in particular a relation of two opposite outer edges of the at least one display content differs in particular by maximally 20%, advantageously maximally 10% and especially advantageously by maximally 5% from a position and/or a size and/or in particular a relation of two opposite outer edges of the at least one display content before a movement of the at least one display unit, in particular for the at least one viewer. A “viewer” is to mean, in this context, in particular a person applying the device, who views the at least one display content of the at least one display unit. Preferably the device comprises a control unit. A “control unit” is to be understood, in particular, as a unit with at least one control electronics equipment, which is in particular provided for actuating the at least one display unit and/or for evaluating measurement values. “Provided” is to mean, in particular, specifically programmed, designed and/or equipped. By an object being provided for a certain function, it is in particular to be understood that the object fulfills and/or carries out said certain function in at least one application state and/or operating state. A “control electronics equipment” is to be understood, in particular, as a unit with a processor unit and with a storage unit as well as with an operating program stored in the storage unit. A “sensor unit” is to be understood, in this context, in particular as a unit which comprises at least one sensor element. By a “sensor element”, in this context, in particular an element is to be understood which is provided to capture in particular physical and/or chemical characteristics and/or the material properties of its surroundings, in a qualitative manner and/or in a quantitative manner as a measurement value. The at least one sensor element is in particular an optical sensor, in particular a camera and preferably a digital camera. An “external reference point” is to be understood, in this context, in particular as a point situated in particular outside a housing or another physical boundary of the at least one device. In particular, the at least one external reference point is situated within a capturing range of the at least one first sensor unit. In particular, the at least one external reference point is optically detectable. By a position of the at least one display unit with respect to at least one external reference point being “captured” by the first sensor unit, it is in particular to be understood, in this context, that in particular at least one measurement value with preferentially geometrical information pertaining to the at least one reference point is captured. In particular, a position of the at least one display unit with respect to the at least one external reference point is identified on the basis of the at least one measurement value. In particular, the position of the at least one display unit is calculated on the basis of the at least one measurement value by a suitable algorithm and/or by a suitable method, e.g. a triangulation. In particular, the at least one external reference point is preferably optically detected by the at least one sensor unit. Preferentially, a plurality of external reference points is detected, preferably at least two external reference points. In particular, when detecting the at least one external reference point at least one measurement value is captured, which preferably comprises angle information and/or distance information with respect to the at least one display unit. Preferably a plurality of measurement values is captured. A capturing of measurement values is preferentially carried out continually and/or in defined time intervals. In particular, the at least one measurement value is transformed into at least one further processable electric signal. In particular, the at least one electric signal is transmitted to and evaluated by the at least one control unit.

By means of the method according to the invention an advantageously exact stabilization of a display content is achievable. This allows a user in particular comfortable and/or low-fatigue viewing of display contents, in particular on mobile display apparatuses, e.g. smartphones, tablet computers, mobile phones, PDAs, e-book readers, navigation apparatuses and similar apparatuses. Furthermore, by capturing a position of the display unit with respect to an external reference point movements with respect to the external reference point may advantageously be captured.

It is further proposed that at least one portion of a viewer's body, in particular a portion of a viewer's face, is used as an external reference point. Preferably the at least one portion of the body, respectively the at least one portion of the face is at least one in particular distinctive feature of the body and/or the face, preferentially at least one eye of a viewer, which is at least substantially unambiguously, in particular optically, capturable. By a feature of a body and/or of a face being at least substantially “unambiguously capturable” it is in particular to be understood, in this context, that the at least one feature is at least substantially distinguishable from other features without incurring a risk of confusion. Preferably a plurality of portions of a body, in particular portions of a face, is used as external reference points. Hereby an advantageous optimization of a stabilization of a display content is achievable with regard to a viewer.

Advantageously, in at least one operating state at least one at least partial adjustment of the at least one display content is implemented, based on at least one measurement value captured by the at least one first sensor unit. Preferentially the at least one at least partial adjustment of the at least one display content is implemented based on a plurality of measurement values. In particular, at least two directly subsequent measurement values are used, which differ in particular due to at least one relative movement between the at least one display unit and the at least one external reference point. An at least partial adjustment of the display content being “implemented” is intended to mean, in particular, that the at least one display unit is actuated by the at least one control unit in such a way that a presentation of the at least one display content is at least partially changed such that the at least one display content is at least partially stabilized for a viewer. As a result of this, advantageously precise adjustments and hence an advantageously exact stabilization of the at least one display content can be achieved.

Moreover it is proposed that the at least one display content is at least partially shifted with respect to the at least one display unit. In particular, the at least one display content is shifted in a plane which at least substantially corresponds to a display plane of the at least one display unit. A “display plane” is to be understood, in this context, in particular as a plane which is formed in particular by a surface of at least one display element of the at least one display unit. In particular, the at least one display plane is arranged on a side of the at least one display unit which faces a viewer. In particular, the at least one display content is shifted at least substantially, in particular by an equivalent absolute value, counter to a movement direction of the at least one display unit. In particular, the at least one display content is shifted by an absolute velocity value which at least substantially corresponds to an absolute velocity value of a movement of the at least one display unit. Preferably the at least one display content is shifted within at least one frame that in particular circumferentially surrounds the at least one display content, which frame is provided to at least partially receive, when a shift takes place, the at least one display content. Advantageously, in particular a width of the at least one frame is increased and/or reduced at least substantially in proportion to an absolute value that has been averaged over a certain time period and/or at least substantially in proportion to a velocity of a movement of the at least one display unit that has in particular been averaged over a certain time period. Hereby an advantageous compensation of movements of a display unit, in particular of movements parallel to a display plane of the display unit, is achievable.

It is further proposed that the at least one display content is at least partially tilted with respect to the at least one display unit. By the at least one display content being at least partially “tilted”, it is in particular to be understood, in this context, that at least a portion of the at least one display content and preferably the entire display content is rotated, in particular about a geometric center point and/or a geometric centroid with respect to the at least one display unit. In particular, the at least one display content is tilted counter to a rotational movement of the at least one display unit. A tilt angle of the at least one display content is herein at least substantially of the same absolute value as a rotational angle of the at least one display unit. As a result of this, an advantageous compensation of rotational movements of a display unit parallel to the display plane of the display unit is achievable.

In a further embodiment it is proposed that at least one partial change in size of the at least one display content is implemented. In particular, the at least one display content is enlarged, in a case of an increasing distance between the at least one display unit and the at least one external reference point, in proportion to the change of distance. In a case of a decreasing distance between the at least one display unit and the at least one external reference point, the at least one display content is reduced in proportion to the change of distance. Hereby fluctuations of a distance between a display unit and a viewer can advantageously be compensated.

Furthermore it is proposed that the at least one display content is at least partially distorted. In particular, the at least one display content is at least partially distorted in case of at least one rotational movement of the at least one display unit about an axis which runs at least substantially parallel to the display plane of the at least one display unit. Herein the term “substantially parallel” is to mean, in particular, an orientation of a direction with respect to a reference direction, in particular in a plane, wherein the direction has a deviation of in particular less than 8°, advantageously less than 5° and especially advantageously less than 2° with respect to the reference direction. Preferentially the at least one display content is presented at least substantially in a trapezoidal distortion. Hereby an advantageous compensation of rotational movements of a display unit about an axis, parallel with respect to the display plane of the display unit is achievable.

It is further proposed that the at least one display content is adjusted in such a way that the at least one display content is at least partially cut down. By the at least one display content being at least partially “cut down” it is to be understood, in this context, in particular that at least a partial region of the at least one display content is cut from a presentation, which partial region is situated outside a display area of the at least one display unit due to an at least partial adjustment, in particular an at least partial shifting and/or tilting and/or enlargement and/or distortion, of the at least one display content. Advantageously, a previously not shown partial region of the at least one display content is presented instead of a partial region of the at least one display content that has been cut off from a presentation. Hereby an optimum compensation of movements of a display unit can be achieved, in particular of movements with huge deflections as regards an absolute value.

Advantageously, in at least one operating state at least one line of vision of at least one eye of a viewer is captured, in particular by the at least one first sensor unit. Preferably a line of vision of both eyes of the viewer is captured. In particular, a line of vision is captured via capturing in particular a pupil and/or an iris of an eye. Preferentially an eye-tracking method is used for capturing the at least one line of vision of an eye of a viewer. Preferably a point and/or a region of the at least one display content, which is focused by the viewer, is determined by capturing the line of vision. This advantageously allows to determine which regions of a display content are of maximum relevance to a viewer.

In a further embodiment it is proposed that at least a region of the at least one display content, which region is situated at least substantially in the at least one line of vision of the at least one eye of the viewer, is adjusted. Advantageously, the at least one display content is only adjusted in the region that is situated at least substantially in the at least one line of vision of the at least one eye of the viewer. In particular, the at least one display content can be kept up without a change in at least one region that is situated outside at least a focusing region of the at least one eye of the viewer. As an alternative, the at least one display content can be at least partially adjusted, in particular shown in a distorted manner, in at least one region that is situated outside a focusing region of the at least one eye of the viewer. Thus an advantageously purposeful stabilization of regions of a display content that are relevant for a viewer is achievable. Moreover a required computing effort for implementing a stabilization is advantageously reducible.

It is furthermore proposed that at least one movement and/or orientation of the at least one display unit is captured by at least one second sensor unit. In particular, the at least one movement and/or orientation of the at least one display unit is captured with respect to a gravitational acceleration direction. In particular, the at least one movement and/or orientation of the at least one display unit is captured by determining at least one measurement value, in particular a force measurement value and/or an acceleration measurement value and/or a bearing measurement value. The at least one measurement value is in particular transformed into at least one further processable electric signal. In particular, the at least one further processable electric signal is transmitted to the at least one control unit. Thus a movement and/or an orientation, in particular a change in orientation, of a display unit can be captured in an advantageously simple manner.

Furthermore it is proposed that the at least one movement and/or orientation of the at least one display unit is captured by means of at least one acceleration sensor and/or at least one gyrosensor. Preferably the at least one movement and/or orientation of the at least one display unit is captured by at least two acceleration sensors and/or by a combination of an acceleration sensor with a gyrosensor. Using acceleration sensors and/or gyrosensors allows advantageously simple application of known sensor principles and/or measuring principles. In particular, acceleration sensors and/or gyrosensors already integrated in mobile display apparatuses are applicable, as a result of which cost may saved.

Advantageously at least one measurement value captured by the at least one second sensor unit can be additionally used to the purpose of at least partially adjusting the at least one display content. In particular, a measurement value captured by the at least one second sensor unit, which in particular shows a change in position and/or bearing of the at least one display unit with respect to the gravitational direction, and at least one measurement value captured by the at least one first sensor unit, which in particular shows a change in position and/or bearing of the at least one display unit with respect to the at least one external reference point, are evaluated together and/or computed with each other by the at least one control unit. This allows advantageously simple implementation of a plausibility check of captured measurement values. Moreover, a combination of measurement values of the at least one first sensor unit and the at least second sensor unit allows an advantageously quick and exact stabilization of the at least one display content. Furthermore, misadjustments and/or undesired adjustments of the at least one display content can advantageously be prevented.

The invention is further based on a device, in particular for utilization in a method according to any one of the preceding claims, with at least one display unit for showing at least one display content and with at least one first sensor unit.

It is proposed that the at least one sensor unit comprises at least one sensor element which is provided to capture a position of the at least one display unit with respect to at least one external reference point. As a result of this, a device can be made available having advantageous features with regard to a stabilization of the at least one display content. In particular, a hardware of already known, in particular mobile display apparatuses can be utilized in a simple and cost-effective manner.

Furthermore, it is proposed that the at least one sensor element of the at least one first sensor unit is implemented as an optical sensor. An “optical sensor” is to mean, in this context, in particular a sensor which is provided to transform at least one optical information into at least one electrically and/or electronically evaluable signal. In particular, the optical sensor captures optical information in the range of light visible to humans and/or in the range of infrared radiation. The optical sensor is preferably embodied as a camera, in particular a front camera and/or a rear-facing camera. In particular, the optical sensor can be embodied as a stereoscopic camera and/or as an infrared camera and/or as a 3D sensor and/or it can be connected to at least one 3D sensor, in particular functionally. A “3D sensor” is to be understood, in this context, in particular as a sensor which is provided to three-dimensionally scan and/or capture in particular an environment. The 3D sensor “three-dimensionally scanning and/or capturing” is to mean, in particular, that data, in particular image data of an environment, which have been in particular optically captured in particular by the 3D sensor itself and/or by an optical sensor coupled with the 3D sensor, are transferred into a three-dimensional model of the environment.

In a further embodiment it is proposed that the at least one sensor element of the at least one first sensor unit is implemented as a 3D sensor. The 3D sensor may use, on its input side, various technologies for three-dimensional scanning and/or capturing of an environment, e.g. multiple individual cameras, a stereoscopic camera, sequential scanning by means of laser beams and/or ultrasonic waves, radar-based scanning and/or a combination thereof. Independent of the type of technology used on the input side, the 3D sensor comprises a data processing unit and/or transmits data to an external data processing unit, which is provided to convert the input signal of the 3D sensor into a spatial, three-dimensional model of the environment, which in particular moves in real-time, and/or into a 3D data set. An output signal of the 3D sensor and/or in particular an output signal of the data processing unit of the 3D sensor contains in particular three-dimensional numerical coordinates of a point cloud or the like representing the scanned and/or captured environment, which may be displayed and/or further processed, in particular for image stabilization. The 3D sensor may be implemented on a front side and/or on a rear side of the device. If the 3D sensor is implemented on the front side of the device, then the 3D sensor is in particular provided to capture at least a portion of a body of the viewer, in particular a portion of a face of a viewer, as an external reference point. If the 3D sensor is implemented on the rear side of the device, then the 3D sensor is in particular provided to capture at least a stationary structure of an environment, e.g. a floor, a ceiling, a wall and/or the like, as an external reference point. 3D sensors of the described kind are especially suitable for achieving an advantageously precise and/or error-free image stabilization method. In particular all parameters necessary for image stabilization can be reliably measured and/or detected, in particular without any technical detours via other inputs.

### DRAWINGS

Further advantages may be gathered from the following description of the drawings. In the drawings an embodiment of the invention is shown. The drawings, the description and the claims contain a plurality of features in combination. The person skilled in the art will expediently also consider the features individually and will combine them into further purposeful combinations.

It is shown in:

FIG. 1 A device for utilization in a method according to the invention,

FIG. 2 The device from FIG. 1 in a lateral view,

FIG. 3 An adjustment of a display content in a horizontal movement of the device from FIG. 1,

FIG. 4 An adjustment of the display content in a vertical movement of the device from FIG. 1,

FIG. 5 A presentation of the vertical movement of the device from FIG. 4,

FIG. 6 An adjustment of the display content in a change of distance between the device and a viewer,

FIG. 7 The change of distance from FIG. 6 in a lateral view,

FIG. 8 An adjustment of the display content in a tilting of the device,

FIG. 9 An adjustment of the display content in a rotation of the device with respect to the viewer,

FIG. 10 The device from FIG. 9 with an adjusted display content in a frontal view,

FIG. 11 An adjustment of the display content with the display content being cut down in a horizontal movement of the device,

FIG. 12 An adjustment of the display content in a horizontal movement of the device, considering a line of vision of the viewer, and

FIG. 13 An adjustment of a region of the display content focused by the viewer in a horizontal movement of the device.

### DESCRIPTION OF THE EXEMPLARY EMBODIMENTS

FIG. 1 shows a frontal view of a device 10 with a display unit 12 as seen by a viewer 18. The eyes 24, 36 of the viewer 18 are depicted symbolically. The device 10 is shown in an exemplary manner as a tablet computer, however other devices with a display unit are conceivable as well, e.g. smartphones or navigation apparatuses. The device 10 is shown in a switched-on operating state. A display content 14 is presented by a display element 38 of the display unit 12 such that it is visible to the viewer 18. The display element 38 is, for example, implemented as an LED display. The display content is circumferentially surrounded by a frame 40. The frame 40 is, in a rest position of the device 10, not used for a presentation of the display content 14.

A first sensor unit 16 is arranged above the display unit 12. The first sensor unit 16 is arranged centrically with respect to the display unit 12. The first sensor unit 16 is integrated in a housing 42 of the device 10. The first sensor unit 16 comprises a sensor element 32, which is embodied as an optical sensor 34. In the embodiment shown in FIG. 1 the sensor element 32 of the first sensor unit 16 is implemented as a front camera 44 of the device 10.

As an alternative, it is conceivable to provide a first sensor unit with a plurality of sensor elements which are implemented as optical sensors. The sensor elements of such an alternative sensor unit are preferably arranged symmetrically above and/or below a display unit and/or laterally to a display unit. Furthermore, using a rear-facing camera, (not shown here) of a device is also conceivable. As an alternative, it is also conceivable that a front camera as well as a rear-facing camera are applied simultaneously. Thus, for example, in dependence of a movement direction of captured image contents of a front camera and a rear-facing camera, in particular based on a same direction and/or a counter direction of the captured image contents, a vertical and/or horizontal tilting and/or shifting can be detected. A front camera as well as a rear-facing camera each can be embodied as a monoscopic and/or stereoscopic and/or infrared camera. In particular when using an infrared camera, this can be equipped with and/or coupled to at least one infrared LED, to the purpose of allowing functioning even in a dark environment. As an alternative, using 3D sensors is also conceivable, which are already in use, for example in game consoles (e.g. Xbox 360 Kinect™) or in personal computers, in particular as control elements and/or input elements.

The first sensor unit 16 continually captures a position of the display unit 12 with respect to an external reference point 20, 46. A portion of a body and/or of a face of a viewer 18 is used as an external reference point 20, 46. In the exemplary embodiment shown in FIG. 1 two external reference points 20, 46 are used. The viewer's eyes 24, 36 are used as external reference points 20, 46. A right eye 36 of the viewer 18 is the first external reference point 20, while a left eye 24 of the viewer 18 is a second external reference point 46. The position of the display unit 12 with respect to the two external reference points 20, 46 is determined via two capturing angles 48, 50 and via two capturing lengths 52, 54, each of which corresponds to a respective distance between the sensor element 32 of the sensor unit 16 and one of the two external reference points 20, 46. FIG. 1 only shows a first capturing angle 48, which is included by the two capturing lengths 52, 54 between the sensor element 32 of the first sensor unit 16 and the two external reference points 20, 46.

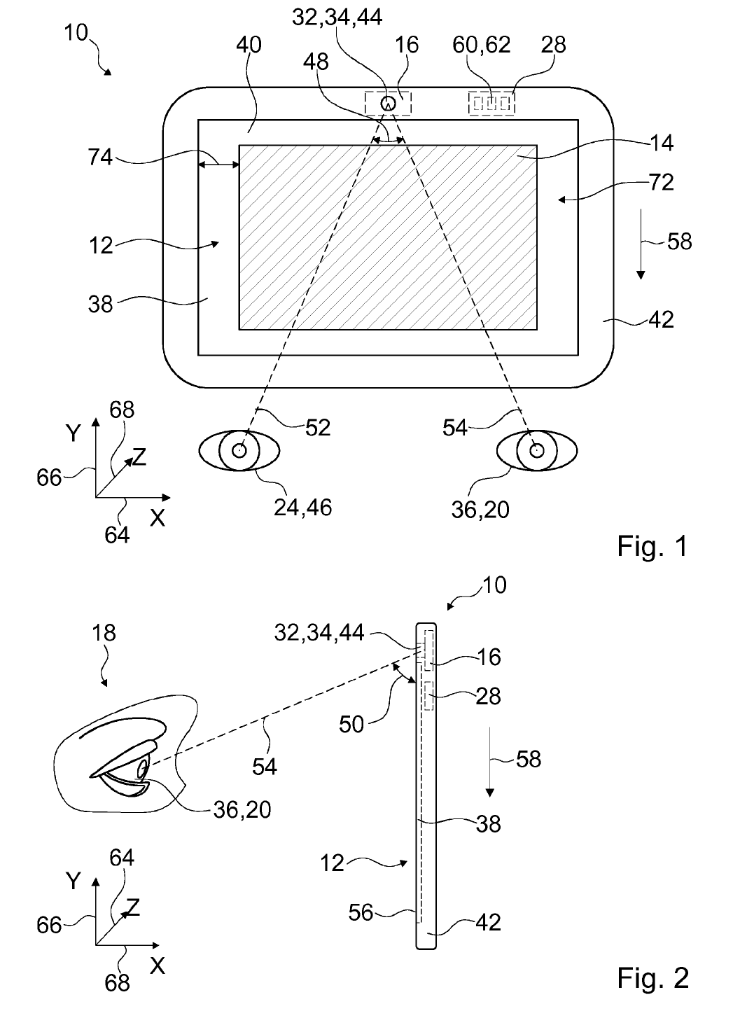

FIG. 2 shows the device 10 and the right eye 36 of the viewer 18 in a lateral view. In this lateral view the second capturing angle 50 can be seen. The second capturing angle 50 is included by a respective one of the two capturing lengths 52, 54 (of which in this view only one capturing length 54 can be perceived) between the sensor element 32 of the first sensor unit 16 and the two external reference points 20, 46 on the one hand and a front side 56 of the display unit 12 on the other hand.

Besides the first sensor unit 16, the device 10 comprises a second sensor unit 28. The second sensor unit 28 is arranged inside a housing 42 of the device 10. The second sensor unit 28 captures movements of the display unit 12 with respect to a gravitational direction 58. The second sensor unit 28 comprises three sensor elements 60, which are implemented as acceleration sensors 62. The sensor elements 60 are arranged in such a way that acceleration values can be captured in three axes 64, 66, 68 that are orthogonal to each other, namely an x-axis 64, a y-axis 66 and a z-axis 68. As an alternative, a second sensor unit is conceivable, having a sensor element that is implemented as a gyrosensor. Further, a second sensor unit is also conceivable, which comprises a combination of different sensor elements, e.g. acceleration sensors and/or gyrosensors.

On the basis of the measurement values captured by the first sensor unit 16 in the form of the capturing angles 48, 50 and the capturing lengths 52, 54, an adjustment of the display content 14 is carried out in case of movements and/or commotions of the device 10. In addition to the measurement values captured by the first sensor unit 16, measurement values captured by the second sensor unit 28 are used to adjust the display content 14.

FIG. 1 shows the device 10 in a use situation in which no adjustment of the display content 14 is carried out. This is, for example, the case when the device 10 is in a rest position. In said rest position, the display unit 12 of the device 10 is not subject to any movements with respect to the gravitational direction 58. Consequentially, no measurement values which can be interpreted as a movement of the display unit 12 with respect to the gravitational direction 58 are captured by the second sensor unit 28. Moreover, in the rest position of the device 10 no measurement values which can be interpreted as a change of the position of the display unit 12 with respect to the eyes 24, 36 of the viewer 18 are captured by the first sensor unit 16.

A further case in which there is no adjustment of the display content 14 occurs if the second sensor unit 28 captures a movement of the display unit 12 in one of the three axes 64, 66, 68 but the first sensor unit 16 does not capture any measurement values indicating a change of the relative position of the display unit 12 with respect to the eyes 24, 36 of the viewer 18. In this case, the measurement values of the first sensor unit 16 and of the second sensor unit 28 are interpreted in combination, namely that the viewer 18 and the display unit 12 are subject to a movement respectively equal in absolute value and direction. As no change of the position of the display unit 12 with respect to the eyes 24, 36 of the viewer 18 occurs in the case of equivalent movements of the viewer 18 and the display unit 12, any adjustment of the display content 14 is expediently omitted.

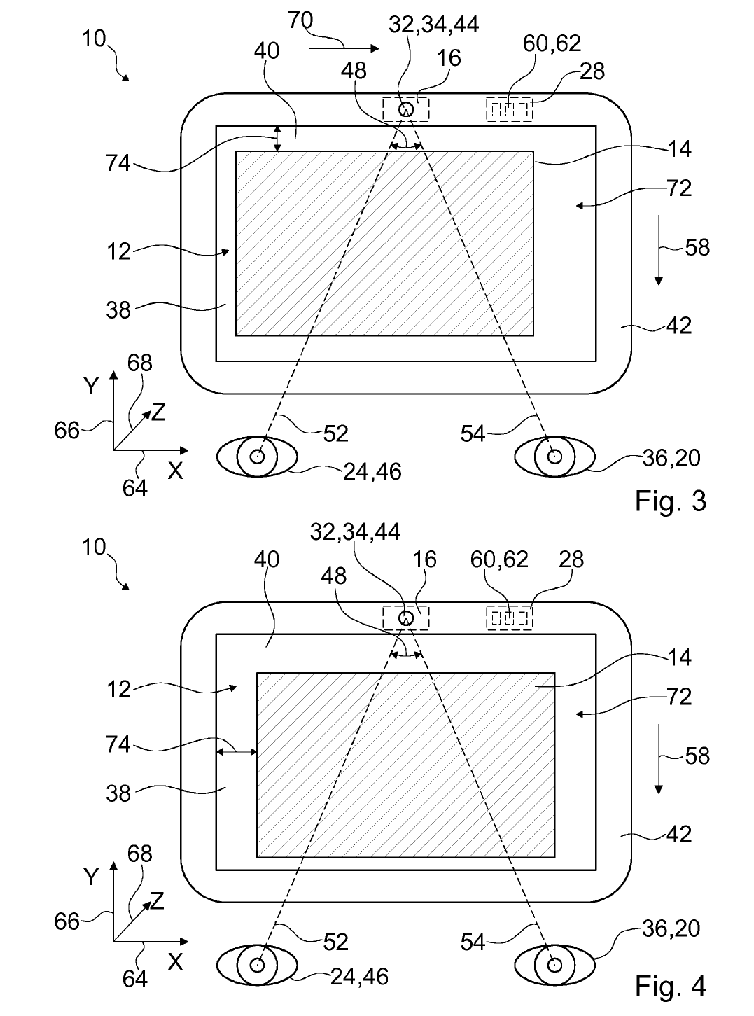

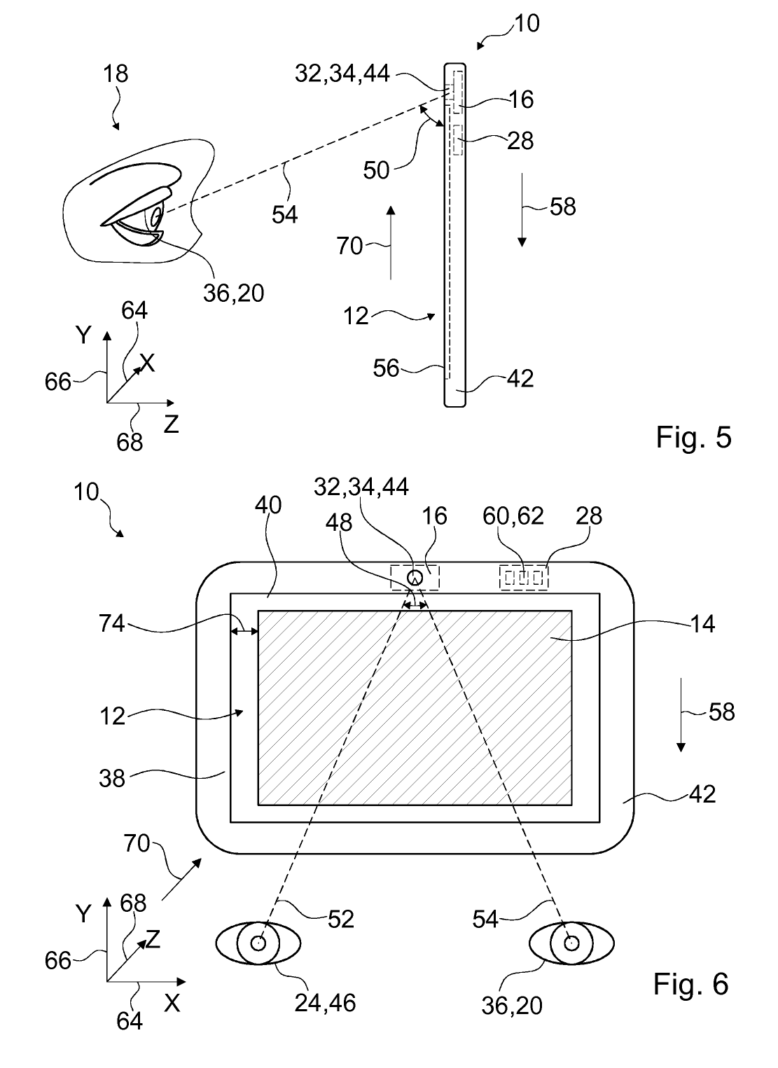

FIG. 3 as well as FIGS. 4 and 5 respectively present an adjustment of the display content 14 in a vertical, respectively horizontal movement of the device 10 with respect to the eyes 24, 36 of the viewer 18. In FIG. 3 a movement direction 70 of the device 10 extends parallel to the x-axis 64. The movement direction 70 of the device 10 extends to the right with respect to the eyes 24, 36 of the viewer 18. The movement of the device 10 also acts, with the same absolute value and direction, on the display unit 12. The movement of the device 10 with respect to the gravitational direction 58 is captured with its absolute value and/or its direction by the second sensor unit 28. In a parallel manner hereto, the first sensor unit 16 continually captures the position of the display unit 12 with respect to the eyes 24, 36 of the viewer 18. Due to the movement of the device 10, the first capturing angle 48 as well as the capturing lengths 52, 54 are respectively subject to a change. Herein the capturing length 52 to the left eye 24 of the viewer 18 is lengthened, while the capturing length 54 to the right eye 36 of the viewer 18 is shortened. By way of capturing the changed measurement values in the form of the capturing angles 48, 50 and the capturing lengths 52, 54, a change in position of the display unit 12 with respect to the eyes 24, 36 of the viewer 18 is determined. On the basis of these measurement values of the first sensor unit 16 and the second sensor unit 28, the display content 14 is shifted with respect to the display unit 12, counter to the movement direction 70 of the device 10, as shown in FIG. 3. The shifting of the display content 14 is implemented with the same absolute value as the movement of the device 10, as a result of which the movement of the device 10 is compensated for the viewer 18. By said shifting of the display content 14, the display content 14 remains for the viewer 18 in its original position, as shown in FIG. 1, and is thus stabilized for the viewer 18. The same applies accordingly for all movements of the device 10 with a movement direction parallel to the x-axis 64.

FIGS. 4 and 5 correspondingly show a shifting of the display content 14 in case of a movement of the entire device 10 with a horizontal movement direction 70 that runs parallel to the y-axis 66. Herein the display unit 12 is subject to an upwards movement with respect to the eyes 24, 36 of the viewer 18. The movement of the entire device 10 with respect to the gravitational direction 58 is captured with its absolute value and its direction by the second sensor unit 28. In a manner parallel hereto the first sensor unit 16 continually captures the position of the display unit 12 with respect to the eyes 24, 36 of the viewer 18. The movement of the entire device 10 results, in this case, in a change of the second capturing angle 50 (cf. FIG. 5). Furthermore, both capturing lengths 52, 54 are lengthened. These changes are captured as measurement values by the first sensor unit 16. The display content 14 is shifted with respect to the display unit 12, in accordance with the measurement values captured by the first sensor unit 16 and the second sensor unit 28, counter to the movement direction 70 of the entire device 10. The shifting of the display content 14 is carried out with the same absolute value as the movement of the entire device 10. As a result of the shifting of the display content 14, the display content 14 remains in its original position as shown in FIG. 1 and is thus stabilized for the viewer 18. The same applies accordingly for movements of the device 10 with a movement direction parallel to the y-axis 66.

In the shifting operations of the display content 14, which are shown in FIGS. 3 and 4, the display content 14 is respectively shifted into the frame 40 which circumferentially surrounds the display content 14 in a rest position of the device 10. A portion of the display content 14 being received by the frame 40 allows the entire display content 14 to be visible for the viewer 18 at any moment in time in case of a movement of the device 10. Shifting of the display content 14 beyond a display area 72 of the display unit 12 is thus effectively prevented. In case of movements of the device 10 with major deflections, it is possible to increase a frame width 74 accordingly, such that these movements are also compensated. In the same way, the frame width 74 can be reduced in case no movements and/or only movements with slight deflections occur.

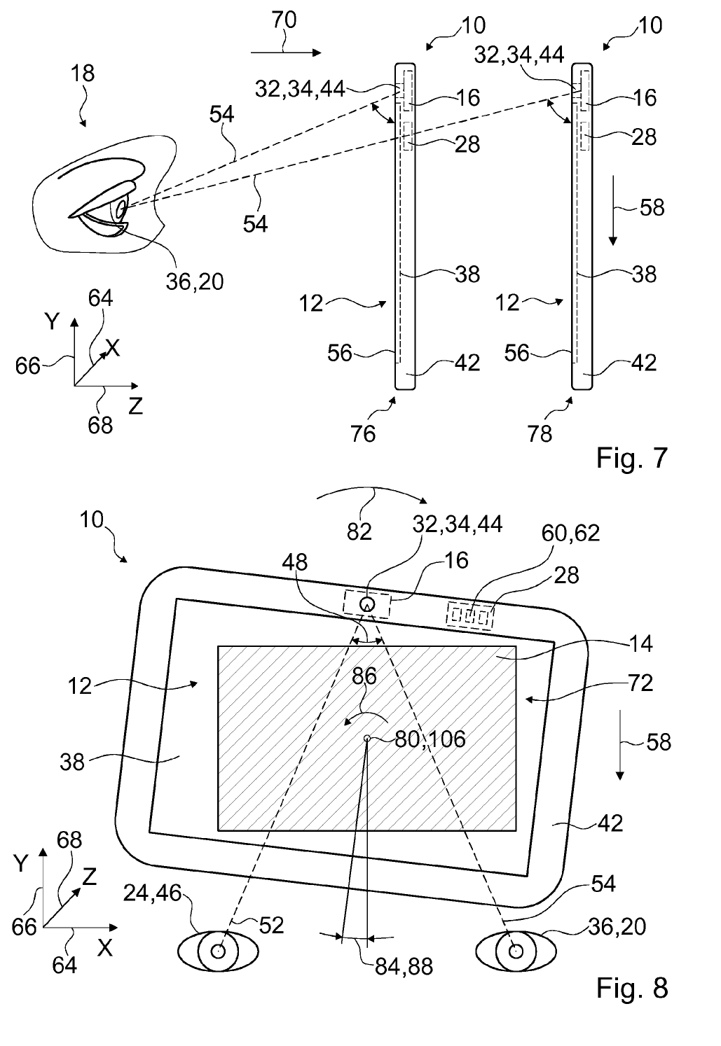

In FIGS. 6 and 7 an adjustment of the display content is depicted in a change of a distance between the device 10 and the eyes 24, 36 of the viewer 18. FIGS. 6 and 7 show a movement of the device 10 with a movement direction 70 parallel to the z-axis 68. The device 10 is herein moved from a first position 76 into a second position 78. With respect to the eyes 24, 36 of the viewer 18, the display unit 12 is subject to a movement with a movement direction 70 that is directed away from the eyes 24, 36 of the viewer 18. The movement is captured, as regards its absolute value and/or direction, by the second sensor unit 28. The first sensor unit 16, in a manner parallel hereto, continually captures the position of the display unit 12 with respect to the eyes 24, 36 of the viewer 18. The movement of the device 10 results both in a change of a first capturing angle 48 (cf. FIG. 6) and a change of a second capturing angle 50 (cf. FIG. 7). The movement of the device 10 further causes a lengthening of the first capturing length 52 and the second capturing length 54. On the basis of the measurement values captured by the first sensor unit 16 and the second sensor unit 28 as capturing angles 48, 50, capturing lengths 52, 54 and movement direction 70, an adjustment of a size of the display content 14 is implemented. In a movement as shown in FIGS. 6 and 7, there occurs an enlargement of the display content 14 in proportion to an increase of the distance between the display unit 12 and the eyes 24, 36 of the viewer 18. The enlargement of the display content 14 compensates for the increase of the distance between the display unit 12 and the eyes 24, 36 of the viewer 18. This results in the size of the display content 14 being kept up, for the viewer 18, without a change, such that the display content 14 is stabilized for the viewer 18. Correspondingly a movement of the device 10 with a movement direction towards the eyes 24, 36 of the viewer 18 results in a reduction of the display content 14 in proportion to a decrease of the distance between the display unit 14 and the eyes 24, 36 of the viewer 18, such that the size of the display content 14 is kept up for the viewer 18 without a change in this case as well.

In FIG. 8 a use situation of the device 10 is shown, in which the device 10 is tilted, with respect to the eyes 24, 36 of the viewer 18, about a tilt axis 80 extending parallel to the z-axis 68. A tilting direction 82 and/or a tilt angle 84 are captured, with respect to the gravitational direction 58, by the second sensor unit 28. In addition, the tilting direction 82 and/or the tilt angle 84 of the display unit 12 are continually captured with respect to the eyes 24, 36 of the viewer 18 by the first sensor unit 16. The capturing of the tilt angle 84 and/or of the tilting direction 82 is carried out by the first sensor unit 16, for example via the second capturing angle 50. As a result of the device 10 being tilted, there is a difference between the capturing angle 50 included by the first capturing length 52 and a front side 56 of the display unit 12 on the one hand and the capturing angle 50 between the second capturing length 54 and a front side 56 of the display unit 12. This difference is captured as a measurement value by the first sensor unit 16. By combination of the measurement values captured by the sensor units 16, 28, a tilting direction 82 and a tilt angle 84 are accurately determinable. On a basis of the captured measurement values, an adjustment of the display content 14 is implemented by tilting the display content 14 with respect to the display unit 12. The tilting of the display content 14 is effected about a geometrical center point 106 of the display content 14. The display content 14 is tilted in a tilting direction 86, which runs counter to the tilting direction 82 of the device 10. A tilt angle 88 of the display content 14 with respect to the display unit 12 has an absolute value equal to the tilt angle 84 of the device 10. The display content 14 is partially tilted into the frame 40. Due to the tilting of the display content 14 with respect to the display unit 12, in a tilting direction 86 that runs counter to the tilting direction 82 of the device 10, an orientation of the display content 14 is kept up for the viewer 18. The display content 14 is thus stabilized for the viewer 18.

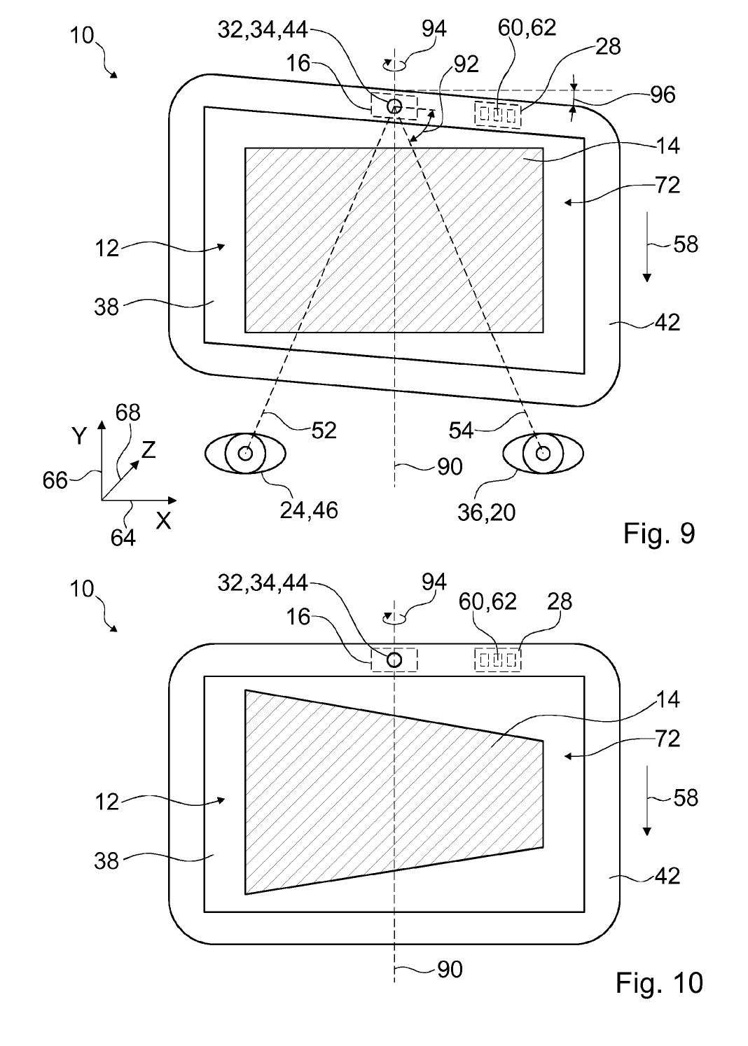

In FIG. 9 a rotation of the device 10 about a rotational axis 90 extending parallel to the y-axis 66 is shown. The display unit 12 is herein rotated, with respect to the eyes 24, 36 of the viewer 18, in a rotational direction 94 that runs clockwise. The following description also applies correspondingly for a counter-clockwise rotation of the device 10. A rotational movement of the device 10 is herein captured by the second sensor unit 28. Herein the rotational direction 94 and/or a rotational angle 96 is captured by the second sensor unit 28. Additionally the position of the device 10 with respect to the eyes 24, 36 of the viewer 18 is continually captured by the first sensor unit 16. In the case of a rotation of the device 10, as shown in FIG. 8, the position is, for example, captured via a capturing angle 92 which is included between one of the capturing lengths 52, 54 and the housing 42 of the device 10. By means of said capturing angle 92 captured as a measurement value by the first sensor unit 16, the rotational angle 96 of the display unit 12 with respect to the eyes 24, 36 of the viewer 18 is determined. By way of a combination of the measurement values captured by the first sensor unit 16 and by the second sensor unit 28, the rotational direction 94 and the rotational angle 96 are accurately determinable. On the basis of the captured measurement values a distortion of the display content 14 is implemented. The distortion of the display content 14 is shown in FIG. 10. FIG. 10 shows the device 10 from FIG. 9 in a frontal view. The frontal view in this case differs from the view of the viewer 18 as the device 10 is rotated with respect to the eyes 24, 36 of the viewer 18, as has been described and is shown in FIG. 9. In the frontal view in FIG. 10 it is shown that the display content 14 is distorted in a trapezoid shape. The display content 14 is distorted partially into the frame 40. The distortion of the display content 14 in the frontal view results in that the display content 14 is not seen to be distorted from the view of the viewer 18, as a result of which the display content 14 is stabilized for the viewer 18.

In FIG. 11 a use situation of the device 10 is depicted, in which the device 10 is subject to a movement with a movement direction 70 that extends to the left with respect to the eyes 24, 36 of the viewer 18. A capturing of the movement direction 70 and of the position of the display unit 12 with respect to the eyes 24, 36 of the viewer 18 is implemented by the first sensor unit 16 and the second sensor unit 28 as already described. In the same way a shifting of the display content 14 with respect to the display unit 12 is implemented as already described. In this case, however, the display content 14 is partially shifted beyond the display area 72 of the display unit 12, counter to the descriptions so far. The display content 14 is thus cut down by a partial region 98. This may occur, for example, if a frame 40 surrounding the display content 14 is dispensed with in favor of achieving an enlarged display area 72, and/or if movements occur which cannot and/or not sufficiently be compensated by an existing frame 40. As is further shown in FIG. 11, instead of the cut-off partial region 98 of the display content 14 a partial region 100 is included that was not shown so far. Thus at any moment in time a display content 14 with a maximum possible information content is presented to the viewer 18. This correspondingly applies for all movements of the device 10 with a movement direction parallel to the x-axis 64 as well as for movements with a movement direction parallel to the y-axis 66.

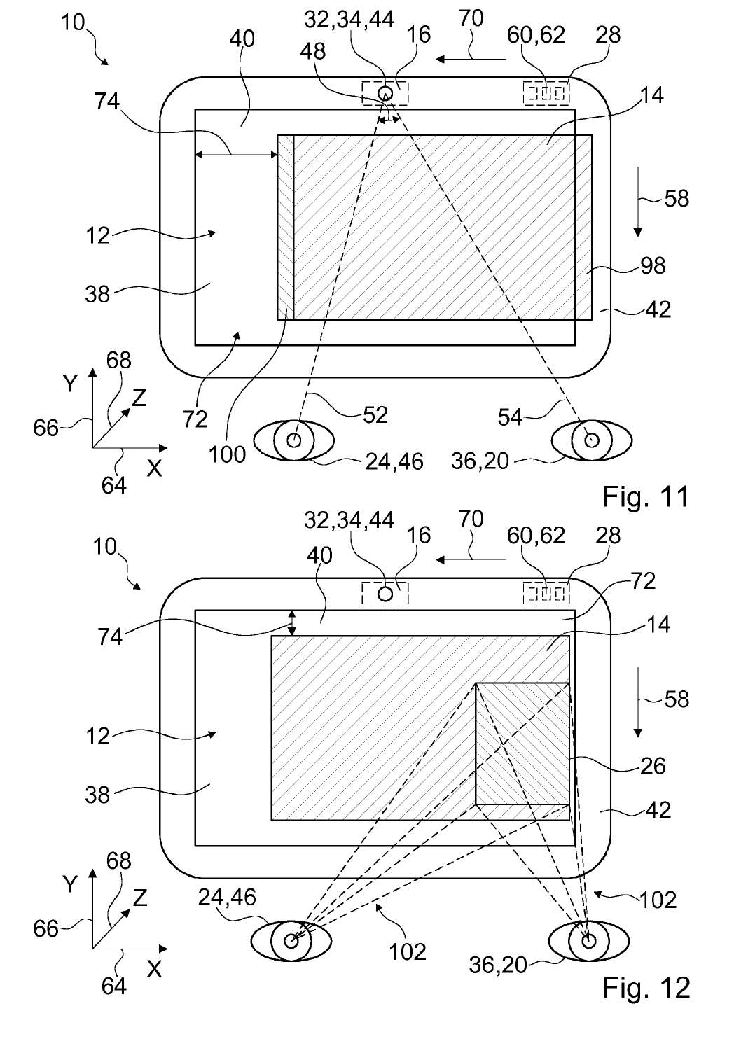

FIG. 12 shows a possibility of preventing a shifting of the display content 14 beyond the display area 72 of the display unit 12. To this purpose, a respective line of vision 102 of each of the eyes 24, 36 of the viewer 18 is additionally captured by the first sensor unit 16. On the basis of the line of vision 102 of the eyes 24, 36 of the viewer 18, it is determined which region 26 of the display content 14 the viewer 18 is focusing. The movement of the device 10 depicted in FIG. 11 corresponds, in its absolute value and in its movement direction 70, to the movement of the device 10 depicted in FIG. 11. However, in FIG. 12 in contrast to FIG. 11, the display content 14 is not shifted beyond the display area 72 of the display unit 12, as the viewer 18 is focusing a region 26 at a righthand edge of the display content 14. As this region 26 has the greatest relevance to the viewer 18 at the moment of the movement of the device 10, it is prevented that the display content 14 is cut down in said region 26.

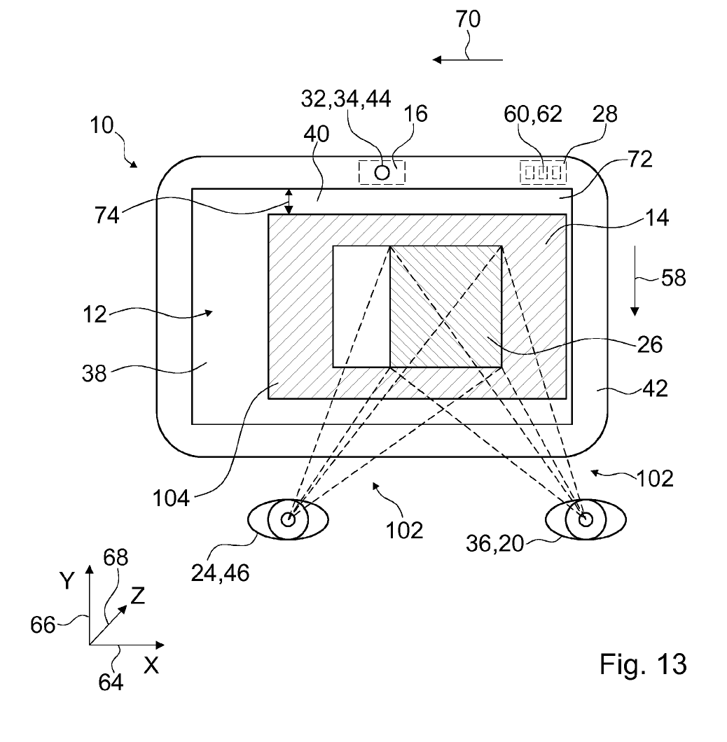

FIG. 13 shows a further possible use, in which a line of vision 102 of the eyes 24, 36 of the viewer 18 is captured by the first sensor unit 16. Movements of the device 10 and of the display unit 12 are captured by the first sensor unit 16 and the second sensor unit 28 as has already been described. In addition, a respective one of each lines of vision 102 of the eyes 24, 36 of the viewer 18 is captured. On the basis of the line of vision 102 of the eyes 24, 36 of the viewer 18 it is determined which region 26 of the display content 14 the viewer 18 is focusing.

The movement of the device 10 shown in FIG. 13 corresponds in its absolute value and in its movement direction 70 to the movement of the device 10 shown in FIGS. 11 and 12. As a difference to the already described adjustment methods for the display content 14, only the region 26 of the display content 14 focused by the viewer 18 is shifted, with respect to the display unit 12, counter to the movement direction 70 of the display unit 12. A region 104 of the display content 14, which is located outside the region 26 focused by the viewer 18, is not adjusted and therefore follows the movement of the display unit 12. As only a comparably small region 26 of the display content 14 is adjusted, movements of the display unit 12 with major deflections can be compensated.

It is to be assumed that in actual use situations of a device 10 described above different movements having different absolute values and/or movement directions are superimposed over each other. In such a case it is easily feasible to combine the described adjustments of the display content 14 accordingly.

Furthermore, there are also use situations conceivable in which it makes sense to deactivate all and/or defined adjustment possibilities for the display content 14. A complete deactivation is, for example, expedient if the viewer 18 purposefully moves with respect to a stationarily fixed device 10 which is not subject to movements. In such a case the movements of the viewer 18 are naturally anticipated and autonomously compensated by the eyes 24, 36 of the viewer 18.

An additional adjustment of the display content 14 would have a disturbing effect on the viewer 18 in such a situation. Merely in case of such movements of the viewer 18 with respect to the display unit 12, which are of such a scale that they cannot be naturally compensated by the eyes 24, 36 of the viewer 18, suitable adjustments of the display content 14 would also be expedient. An activation and/or deactivation of the adjustment possibilities described may be implemented manually by the viewer 18 and/or in an automated manner by the device 10, e.g. on the basis of presettings.

1-16. (canceled)

17. A method for image stabilization, comprising the steps of:
providing at least one display unit (12) for presenting at least one display content (14);
providing at least one first sensor unit (16);
stabilizing the at least one display content (14) of the at least one display unit (12) for at least one viewer (18);
capturing a position of the at least one display unit (12) with respect to at least one external reference point (20, 46) by the at least one first sensor unit (16).

18. The method according to claim 17, further comprising the step of using at least a portion of a body of the viewer (18) as the external reference point (20, 46).

19. The method according to claim 18, wherein the at least a portion of the body of the viewer (18) is a portion of a face of the viewer (18).

20. The method according to claim 17, further comprising the step of implementing, in at least one operating state, at least one at least partial adjustment of the at least one display content (14) based on at least one measuring value captured by the at least one first sensor unit (16).

21. The method according to claim 20, wherein the at least one display content (14) is at least partially shifted with respect to the at least one display unit (12).

22. The method according to claim 20, wherein the at least one display content (14) is at least partially tilted with respect to the at least one display unit (12).

23. The method according to claim 20, further comprising the step of implementing at least a partial change in size of the at least one display content (14).

24. The method according to claim 20, further comprising at least partially distorting the at least one display content (14).

25. The method according to claim 20, further comprising adjusting the at least one display content (14) in such a way that the at least one display content (14) is at least partially cut down.

26. The method according to claim 17, further comprising capturing at least one line of vision (102) of at least one eye (24) of a viewer (18) in at least one operating state.

27. The method according to claim 26, wherein the at least one line of vision (102) is captured by the at least one first sensor unit (16).

28. The method according to claim 26, further comprising adjusting at least one region (26) of the at least one display content (14), wherein said at least one region (26) is situated at least substantially in the at least one line of vision (102) of the at least one eye (24) of the viewer (18).

29. The method according to claim 17, further comprising capturing at least one movement and/or orientation of the at least one display unit (12) by at least one second sensor unit (28).

30. The method according to claim 29, further comprising capturing at least one movement and/or orientation of the at least one display unit (12) by at least one acceleration sensor (62) and/or at least one gyrosensor.

31. The method according to claim 29, further comprising additionally using at least one measuring value captured by the least one second sensor unit (28) for at least partial adjustment of the at least one display content (14).

32. A device (10) for performing the method according to claim 17, comprising:
at least one display unit (12) for presenting at least one display content (14);
at least one first sensor unit (16) comprising at least one sensor element (32), wherein said at least one sensor element (32) is configured to capture a position of the at least one display unit (12) with respect to at least one external reference point.

33. The device (10) according to claim 32, wherein the at least one sensor element (32) of the at least one first sensor unit (16) is implemented as an optical sensor.

34. The device (10) according to claim 32, wherein the at least one sensor element (32) of the at least one first sensor unit (16) is implemented as a 3D sensor.
